(19) United States
(12) Patent Application Publication
(10) Pub. No.: US 2008/0081648 A1
(43) Pub. Date: Apr. 3, 2008

(54) Apparatus and method for minimizing number of transcodings in multi-network multi-codec environment

(76) Inventors: Tae Gyu Kang, Daejeon-city (KR); Ki Jong Koo, Daejeon-city (KR); Dae Ho Kim, Daejeon-city (KR); Do Young Kim, Daejeon-city (KR); Hae Won Jung, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/702,275

(22) Filed: Feb. 5, 2007

(30) Foreign Application Priority Data
Sep. 29, 2006 (KR) 10-2006-0096457

(51) Int. Cl. H04B 7/00

(52) U.S. Cl. 455/500

(57) ABSTRACT

Provided is a method and apparatus for minimizing the number of transcodings between network devices in a multi-network multi-codec environment. The method includes: creating a received codec list by receiving a transmit codec comprised in a call setting message from a transmission device and the number of transcodings of the transmit codec, which has been performed from a codec of an initial transmission device; creating a codec Quality of Service (QoS) list containing total codecs of the multi-network and quality information of each of the total codecs; creating a transcodec list containing internally providable transcodecs and quality information of the transcodecs based on the codec QoS list; and creating an updated codec list by adding codecs of the transcodec list matching codecs of the received codec list to the received codec list and adjusting codec priority according to the number of transcodings. Accordingly, since the number of transcodings can be minimized, a quality decrease of original media can be minimized.

### CROSS-REFERENCE TO RELATED PATENT APPLICATION

This application claims the benefit of Korean Patent Application No. 10-2006-0096457, filed on Sep. 29, 2006, in the Korean Intellectual Property Office, the disclosure of which is incorporated herein in its entirety by reference.

### BACKGROUND OF THE INVENTION

1. Field of the Invention

The present invention relates to a technique of minimizing the number of transcodings when a call is connected between a transmission terminal and a final reception terminal in a multi-network multi-codec environment, and more particularly, to a method and apparatus for preventing a decrease of quality of original media by minimizing the number of transcodings being performed by a plurality of transcoding devices in a case where a sender and a receiver have different codecs when a real-time multimedia service is provided by performing an internetworking function between a packet network, a mobile communication network, a Wireless Local Area Network (WLAN), a cable network, and an existing wired/wireless network.

2. Description of the Related Art

Transcodec has an advantage of allowing devices having different codecs to communicate with each other by changing a codec and also has a disadvantage of a decrease of quality of original media according to an increase of the number of transcodings due to the transcodec. Thus, by providing an apparatus and method for minimizing the number of transcodings when a call is connected between a sender and a receiver in a multi-network multi-codec environment, a decrease of quality of original media must be minimized.

U.S. Pat. No. 7,023,819 (“Method of Reducing the Number of Vocoders in Wireless Network”, Apr. 4, 2006) relates to a Tandem Free Operation (TFO) method for avoiding transcoding, which is a method applied to a case where a sender and a receiver have the same codec and other codecs intermediate.

Korean Patent Publication No. 2005-0082340 (“Multi-transcoding Service Method Using Web Service”, Aug. 23, 2005) relates to a method of performing transcoding by collecting transcoders in a web server.

Korean Patent Publication No. 2004-0098143 (“Transcoding Method between Other Codecs in Communication System”, Nov. 20, 2004) also relates to The TFO method for avoiding transcoding, which is a method applied to a case where a sender and a receiver have the same codec and other codecs intermediate.

U.S. Pat. No. 6,856,612 (“Method and Systems for Call Routing and Codec Negotiation in Hybrid Voice/Data/Internet/Wireless System”, Feb. 15, 2005) relates to a method of reducing the number of transcodings using Primary Inter-exchange Carrier (PIC) identity to minimize the number of transcodings with a TFO function.

U.S. Pat. Publication No. 2003/0048795 (“Gateway between Digital Signal Transmission Networks”, Mar. 13, 2003) relates to a method of saving expenses by first connecting a domestic call when an international call or the domestic call is connected.

U.S. Pat. Publication No. 2003/0026289 (“Transcoding SMS-based Streamed Messages to SIP-based IP Signals in Wireless and Wireline Networks”, Feb. 6, 2003) relates to Short Message Service (SMS)-based transcoding based on the Session Initiation Protocol (SIP).

U.S. Pat. Publication No. 2002/0122481 (“Transcoding Method and Transcoding Apparatus”, Sep. 5, 2002) relates to a coding method for transcoding.

The above-described prior arts cannot minimize the number of transcodings in a multi-network multi-codec environment. Thus, when transcoding is provided between network devices connected between multiple networks, a method of providing higher media quality by selecting codecs to minimize the number of transcodings using transcoding information previously transmitted to a receiver is required.

### SUMMARY OF THE INVENTION

The present invention provides a method and apparatus for minimizing the number of transcodings in order to minimize a decrease of quality of original media transmitted from a sender to a receiver in a real-time multimedia service of a multi-network multi-codec environment.

The present invention also provides a computer readable recording medium storing a computer readable program for executing a method of minimizing the number of transcodings in order to minimize a decrease of quality of original media transmitted from a sender to a receiver in a real-time multimedia service of a multi-network multi-codec environment.

According to an aspect of the present invention, there is provided a method of minimizing the number of transcodings between network devices in a multi-network multi-codec environment, the method comprising: creating a received codec list by receiving a transmit codec comprised in a call setting message from a transmission device and the number of transcodings of the transmit codec, which has been performed from a codec of an initial transmission device; creating a codec Quality of Service (QoS) list containing total codecs of the multi-network and quality information of each of the total codecs; creating a transcodec list containing internally providable transcodecs and quality information of the transcodecs based on the codec QoS list; and creating an updated codec list by adding codecs of the transcodec list matching codecs of the received codec list to the received codec list and adjusting codec priority according to the number of transcodings.

The creating of the updated codec list may comprise adding codecs of a transcodec matching by comparing a first codec of the transcodec list to codecs of the received codec list to the received codec list together with the number of transcodings performed from the codec of the initial transmission device.

The creating of the updated codec list may comprise if the number of transcodings is the same, adjusting priorities of codecs of the updated codec list using the transcodec quality information of the transcodec list. The created updated codec list may be transmitted to a second reception device.

According to another aspect of the present invention, there is provided a method of minimizing the number of transcodings between network devices in a multi-network multi-codec environment, the method comprising: creating a received codec list by receiving a transmit codec comprised in a call setting message from a transmission device and the number of transcodings of the transmit codec, which has been performed from a codec of an initial transmission device; and selecting a codec having the highest priority among at least one internal codec as a response codec based on the number of transcodings of the received codec list.

The method may further comprise: if the at least one internal codec has the same priority, creating a codec Quality of Service (QoS) list containing total codecs of the multiple networks and quality information of each of the total codecs; and selecting a codec having the highest priority as a response codec based on the codec quality information of the codec QoS list.

According to another aspect of the present invention, there is provided a transcoding device for minimizing the number of transcodings between network devices in a multi-network multi-codec environment, the transcoding device comprising: a received codec list creator creating a received codec list by receiving a transmit codec comprised in a call setting message from a transmission device and the number of transcodings of the transmit codec, which has been performed from a codec of an initial transmission device; a codec Quality of Service (QoS) list creator creating a codec QoS list containing total codecs of the multi-network and quality information of each of the total codecs; a transcodec list creator creating a transcodec list containing internally providable transcodecs and quality information of the transcodecs based on the codec QoS list; and an updated codec list creator creating an updated codec list by adding codecs of the transcodec list matching codecs of the received codec list to the received codec list and adjusting codec priority according to the number of transcodings.

The updated codec list creator may create the updated codec list by adding codecs of a transcodec matching by comparing a first codec of the transcodec list to codecs of the received codec list to the received codec list together with the number of transcodings performed from the codec of the initial transmission device.

The updated codec list creator may create the updated codec list by adjusting priorities of codecs of the updated codec list using the transcodec quality information of the transcodec list if the number of transcodings is the same.

According to another aspect of the present invention, there is provided a reception device for minimizing the number of transcodings between network devices in a multi-network multi-codec environment, the reception device comprising: a received codec list creator creating a received codec list by receiving a transmit codec comprised in a call setting message from a transmission device and the number of transcodings of the transmit codec, which has been performed from a codec of an initial transmission device; and a response codec selector selecting a codec having the highest priority among at least one internal codec as a response codec based on the number of transcodings of the received codec list.

The reception device may further comprise a codec Quality of Service (QoS) list creator creating a codec QoS list containing total codecs of the multiple networks and quality information of each of the total codecs. The response codec selector may select a codec having the highest priority as a response codec based on the codec quality information of the codec QoS list if the at least one internal codec has the same priority.

According to another aspect of the present invention, there is provided a computer readable recording medium storing a computer readable program for executing a method of minimizing the number of transcodings between network devices in a multi-network multi-codec environment.

The present invention relates to an apparatus and method for minimizing the number of transcodings in a case where a call is connected between a sender and a receiver having different codecs when a real-time multimedia service is provided in a multi-network multi-codec environment and can be used for quality-guaranteed Internet telephony using Voice over Internet Protocol (VoIP).

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a multi-network multi-codec configuration according to an embodiment of the present invention;

FIG. 2 is a block diagram of a transcoding device and a final reception device according to an embodiment of the present invention;

FIGS. 3A through 3D illustrate codec list tables created in an apparatus according to an embodiment of the present invention;

FIG. 4 is a flowchart illustrating a method of minimizing the number of transcodings according to an embodiment of the present invention; and

FIGS. 5A and 5B are block diagrams showing illustrations in which the number of transcodings is minimized according to an embodiment of the present invention.

### DETAILED DESCRIPTION OF THE INVENTION

The objectives, characteristics, and merits of the present invention will be described in detail by explaining preferred embodiments of the invention with reference to the attached drawings, so that those of ordinary skill in the art can easily implement the spirit and scope of the present invention. In the following description, well-known functions or constructions are not described in detail since they would obscure the invention with unnecessary detail. Hereinafter, the present invention will be described more fully with reference to the accompanying drawings, in which exemplary embodiments of the invention are shown.

In the embodiments described below, a call processing flow between a sender and a receiver is based on the Internet Engineering Task Force (IETF) or the International Telecommunication Union—Telecommunication Standardization Sector (ITU-T) standards. Here, a call processing flow from the receiver to the sender, which can be covered by the IETF or ITU-T standards, observes the IETF or ITU-T standards, and only contents not described in the IETF or ITU-T standards will be described.

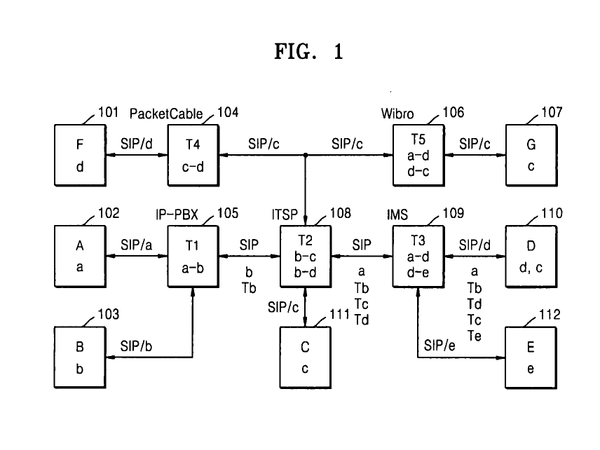

FIG. 1 illustrates a multi-network multi-codec configuration according to an embodiment of the present invention.

Referring to FIG. 1, A 102, B 103, C 111, D 110, E 112, F 101, and G 107 denote terminals having a codec and connected to a network. T1 105, T2 108, T3 109, T4 104, and T5 106 denote network components as transcoding devices having a transcoding function and can be Internet Protocol—Private Branch exchange (IP-PBX), Internet Telephony Service Provider (ITSP), IP Multimedia Subsystem (IMS), PacketCable, and Wireless Broadband (Wibro) devices, etc. A session between a terminal and a terminal, a terminal and a transcoding device, or a transcoding device and a transcoding device is connected using the Session Initiation Protocol (SIP) or H.323, and the session connection is performed with transfer of codec information. English lowercase characters a, b, c, d, and e denote codecs, and a-b, b-c, c-d, b-d, a-d, and d-e denote transcodecs.

For example, since the codec a of the terminal A 102 is different from the codec d or c of the terminal D 110, the terminal A 102 cannot communicate with the terminal D 110 in real-time. Thus, the terminal A 102 and the terminal D 110 can communicate with each other by transcoding the codec a to the codec b in the transcoding device T1 105 and the codec b to the codec c or d in the transcoding device T2 108. However, a plurality of transcodings cause a decrease of quality of original media.

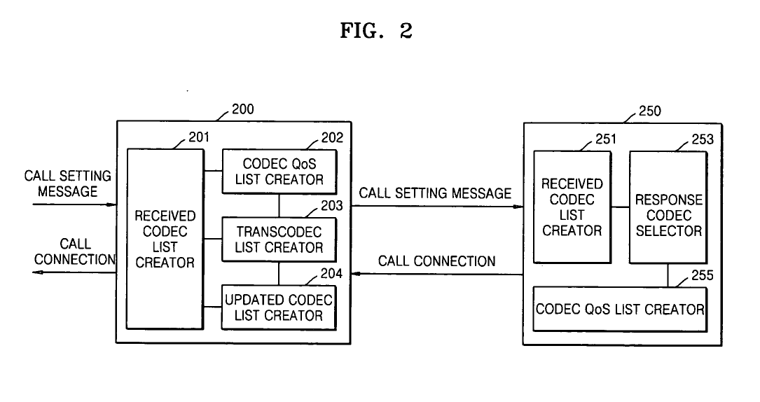

FIG. 2 is a block diagram of a transcoding device 200 and a final reception device 250 of a receiver, for minimizing the number of transcodings in the multi-network multi-codec configuration illustrated in FIG. 1, according to an embodiment of the present invention.

Referring to FIG. 2, the transcoding device 200 creates a received codec list by receiving a call setting message from a transmission device (not shown), creates an updated codec list by referring to an internal transcodec list, and transmits the updated codec list to a subsequent device (e.g., another transcoding device, or the final reception device 250). The call setting message from the transmission device contains a codec of an initial transmission device (not shown), codecs added while passing through network devices from the initial transmission device to the transmission device, and the number of transcodings indicating how many times the codecs (the codec of the initial transmission device and added codecs) are changed from the codec of the initial transmission device.

The final reception device 250 of the receiver creates a final received codec list by receiving the updated codec list from the transcoding device 200 and connects a call to the initial transmission device by selecting a codec having the highest priority in the final received codec list from among codecs included in the final reception device 250.

The transcoding device 200 includes a received codec list creator 201, a codec Quality of Service (QoS) list creator 202, a transcodec list creator 203, and an updated codec list creator 204, and the final reception device 250 includes a received codec list creator 251 and a response codec selector 253.

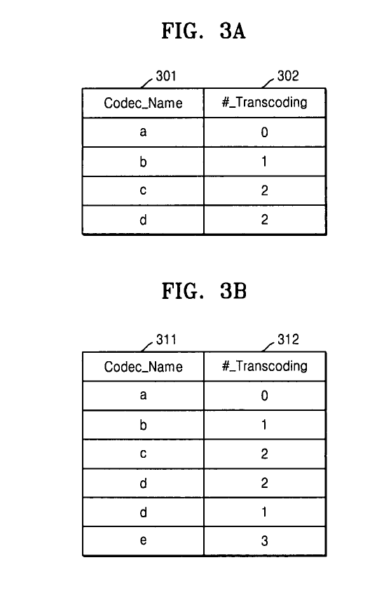

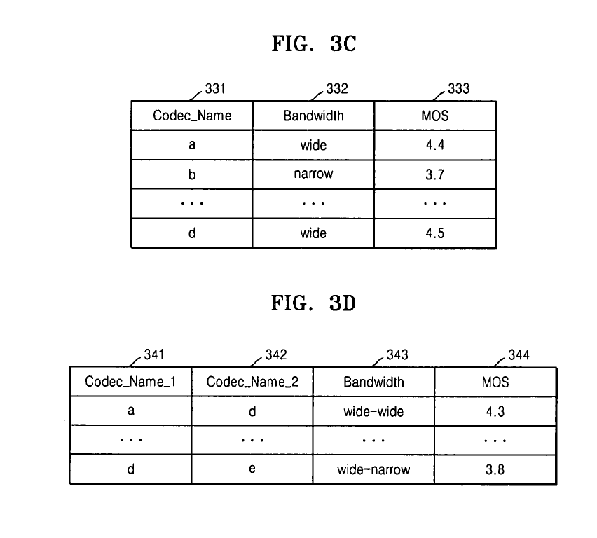

List tables created by the components of the transcoding device 200 will now be described with reference to FIGS. 3A through 3D. FIGS. 3A through 3D are described in a point of view of the transcoding device T3 109 of FIG. 1.

FIG. 3A shows an illustration of a received codec list created by the received codec list creator 201. The received codec list includes a Codec_Name field 301 and a #_Transcoding field 302. The Codec_Name field 301 records names of codecs carried on a call setting message of a transmission device, and the #_Transcoding field 302 records the number of transcodings needed when each codec is transcoded from the codec of the initial transmission device. The received codec list illustrated in FIG. 3A in the point of view of the transcoding device T3 109 indicates that the number of transcodings of the codec a is 0, the number of transcodings of the codec b is 1 (a→b), the number of transcodings of the codec c is 2 (a→b→c), and the number of transcodings of the codec d is 2 (a→b→d).

FIG. 3B shows an illustration of an updated codec list created by the updated codec list creator 204. The updated codec list includes a Codec_Name field 311 and a #_Transcoding field 312 as well as the received codec list. However, in the contents, the received codec list is included in the updated codec list. That is, the updated codec list creator 204 creates the updated codec list by searching for codecs of a transcodec list (referring to FIG. 3D) matching the codecs of the received codec list, comparing a value of a Bandwidth field 343 of the transcodec list and a value of a Mean Opinion Score (MOS) field 344 with respect to the found codecs, and inserting the found codecs into the received codec list in an order of excellent quality.

FIG. 3C shows an illustration of a codec QoS list created by the codec QoS list creator 202. The codec QoS list includes a Codec_Name field 331, a Bandwidth field 332, a MOS field 333 and is used when the transcodec list is created and when the final reception device 250 selects a single response codec for a call connection among selectable codecs. That is, when there are many selectable codecs having the same number of transcodings, a codec is selected by comparing codec quality such as a bandwidth and a MOS, and in this case, in the Bandwidth field 332, ‘wideband’ is selected earlier than ‘narrowband’, and if the bandwidth is the same, a codec having a higher value of the MOS field 333 is selected earlier than a codec having a lower value.

FIG. 3D shows an illustration of a transcodec list created by the transcodec list creator 203. The transcodec list includes a Codec_Name_1 field 341, a Codec_Name_2 field 342, the Bandwidth field 343, and the MOS field 344, stores a list of transcodecs (first codec and second codec for each transcodec) providable in a system, and is used when codecs are added to the received codec list in order to create the updated codec list.

Referring back to FIG. 2, the transcoding device 200 creates a received codec list from a received list of codecs and creates an updated codec list by comparing a transcodec list created by referring to a codec QoS list to the received codec list.

The created and transmitted updated codec list is transmitted to a subsequent reception device, and if the subsequent reception device is the final reception device 250, the received codec list creator 251 of the final reception device 250 creates a final received codec list from a received updated codec list, and the response codec selector 253 selects a codec having the highest priority in the received codec list among a codec list included in the final reception device 250 as a response codec. If there exist a plurality of codecs having the same priority due to the same number of transcodings, by detecting codec quality information from a codec QoS list created by a codec QoS list creator 255, a codec having a wider bandwidth may be first selected, and if there exist a plurality of codecs having the same bandwidth, a codec having a higher MOS may be first selected.

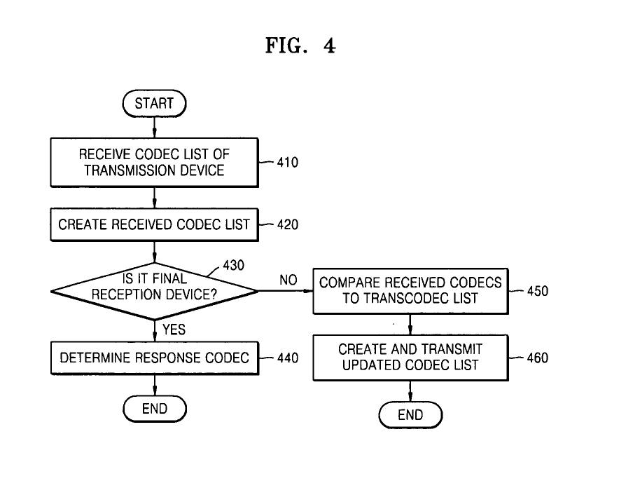

FIG. 4 is a flowchart illustrating a method of minimizing the number of transcodings according to an embodiment of the present invention.

According to the method illustrated in FIG. 4, a received codec list is created by receiving a transmit codec comprised in a call setting message from a transmission device and the number of transcodings of the transmit codec, which has been performed from a codec of an initial transmission device, a codec QoS list containing total codecs of the multiple networks and quality information of each of the total codecs is created, a transcodec list containing internally providable transcodecs and quality information of the transcodecs is created based on the codec QoS list, an updated codec list is created by adding codecs of the transcodec list matching codecs of the received codec list to the received codec list and adjusting codec priority according to the number of transcodings, and the updated codec list is transmitted to a subsequent reception device.

Referring to FIG. 4, when a reception device receives a SIP or H.323 message transmitted from a transmission device, the reception device receives codecs of the transmission device, which is included in the message, and the number of transcodings of each of the codecs, which has been performed from a codec of an initial transmission device, in operation 410.

A received codec list is created by recording the received codecs and the number of transcodings of each of the received codecs in operation 420. In this case, a received order must be input as it is, and the order must not be changed.

The reception device determines in operation 430 whether it is a final reception device.

If it is determined in operation 430 that the reception device is not the final reception device, the reception device determines in operation 450 whether there exists a transcodec in which a codec name of the received codec list matches a first codec name of a transcodec list.

If it is determined in operation 450 that there exists a transcodec, the reception device creates an updated codec list by adding a first codec and a second codec of the transcodec below the received codec list and adjusting an order of the codecs and transmits the updated codec list to a subsequent reception device in operation 460. When the first and second codecs of the transcodec are added, the reception device first adds a codec having the highest priority by referring to codec quality information of the transcodec list. FIG. 3B shows an illustration of a list of codecs added in a point of view of the transcoding device T3 109. According to the order adjustment of the codecs of the updated codec list after the codecs are added, a response codec may be determined by arranging the codecs in an order where the number of transcodings required from the codec of the initial transmission device is larger, selecting codecs in an order where a bandwidth is wider if the number of transcodings is the same, and selecting codecs in an order where a MOS is higher if the bandwidth is the same.

According to the order adjustment, the number of transcodings of the added first codec is compared to that of a codec having the lowest priority in the received codec list, if the first codec has a higher priority, their codec orders are exchanged, this procedure is repeated until a codec having the highest priority, and if the procedure is completed, the number of transcodings, a bandwidth, or a MOS of the second codec added by the transcodec list is compared to that of each of the codecs in the received codec list, and if the comparison and exchange operation is completed for the codecs added by the transcodec list, since the order adjustment is completed, an updated codec list is created.

If it is determined in operation 430 that the reception device is the final reception device, the reception device determines a codec having the highest priority in the received codec list among codecs included in the reception device as a response codec in operation 440. If more than one codec has the same highest priority due to the same number of transcodings, a codec having a wider bandwidth in the codec QoS list may be selected as the response codec, and if the more than one codec also has the same highest priority due to the same bandwidth, a codec having a higher MOS may be selected as the response codec.

According to the prior art, since transcodec information is not used even in the multi-network multi-codec environment, a call connection fails or a delay occurs by reconnecting the transcoding function after the connection failure, and QoS decreases due to an increase of the number of transcodings. However, by using the method according to an embodiment of the present invention, possibility of call connection failure decreases, and the number of transcodings can be minimized, resulting the minimization of a decrease of quality of original media.

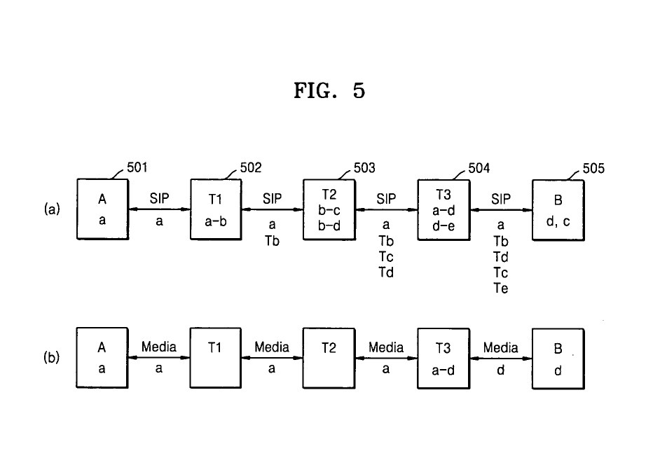

FIG. 5 illustrates a result of an illustration performed based on FIGS. 1 through 4, according to an embodiment of the present invention.

Referring to FIG. 5(a), when a terminal A 501 having a codec a desires to communicate in real-time with a terminal B 505 having codecs d and c, transcoding devices T1, T2, and T3 502, 503, and 504 have the transcoding function.

The transcoding device T1502 transmits the codec a (the number of transcodings is 0) and a codec b (the number of transcodings is 1), which is added by a transcodec a-b included in the transcoding device T1 502, to the transcoding device T2 503. The transcoding device T2 503 transmits the received codecs a and b and codecs c (the number of transcodings is 2) and d (the number of transcodings is 2), which are added by a transcodec c-d thereof, to the transcoding device T3 504. The transcoding device T3 504 adds codecs d and e to the received codecs a, b, c, and d. The added codec d overlaps the received codec d, and since the added codec d can be directly transcoded from the codec a by a transcodec a-d of the transcoding device T3 504, the number of transcodings of the added codec d is 1, and thus the added codec d has the higher priority than the received codecs c (the number of transcodings is 2) and d (the number of transcodings is 2). Thus, an order of the added codec d is adjusted to a next order of the codecs a and b, and an updated codec list in which the order adjustment is completed is transmitted to the terminal B 505. The terminal B 505 connects a call with the terminal A 501 by selecting the codec d having the higher priority from among the codecs d and c included in the terminal B 505.

A result in which the call is connected between the terminal A 501 and the terminal B 505 is illustrated in FIG. 5(b). Referring to FIG. 5(b), the codec a is transferred to the transcoding device T3 504 via the terminal A 501, the transcoding device T1 502, and the transcoding device T2 503, and transcoded to the codec d by the transcoding device T3 504, and finally the codec d is transmitted to the terminal B 505. Thus, 3 transcodings (a to b, b to c, and c to d) or 2 transcodings (a to b and b to c) can be reduced to 1 transcoding (a to d).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to the present invention, since the conventional problems of call connection failure due to transcodec information unused even in a multi-network multi-codec environment, a delay occurring due to reconnection of the transcoding function after the connection failure, and a QoS decrease due to an increase of the number of transcodings can be overcome, the possibility of call connection failure decreases.

In addition, when network devices connected between a sender and a receiver provide a transcoding function since a codec of the sender is different from a codec of the receiver in the multi-network multi-codec environment, the number of transcodings is minimized by transferring transcoding information and selecting a codec having the minimum number of transcodings, resulting in the minimization of a quality decrease of original media.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of minimizing the number of transcodings between network devices in a multi-network multi-codec environment, the method comprising:
creating a received codec list by receiving a transmit codec comprised in a call setting message from a transmission device and the number of transcodings of the transmit codec, which has been performed from a codec of an initial transmission device;
creating a codec Quality of Service (QoS) list containing total codecs of the multi-network and quality information of each of the total codecs;
creating a transcodec list containing internally providable transcodecs and quality information of the transcodecs based on the codec QoS list; and
creating an updated codec list by adding codecs of the transcodec list matching codecs of the received codec list to the received codec list and adjusting codec priority according to the number of transcodings.

2. The method of claim 1, wherein the creating of the updated codec list comprises adding codecs of a transcodec matching by comparing a first codec of the transcodec list to codecs of the received codec list to the received codec list together with the number of transcodings performed from the codec of the initial transmission device.

3. The method of claim 2, wherein the creating of the updated codec list comprises if the number of transcodings is the same, adjusting priorities of codecs of the updated codec list using the transcodec quality information of the transcodec list.

4. The method of claim 1, wherein the created updated codec list is transmitted to a second reception device.

5. A method of minimizing the number of transcodings between network devices in a multi-network multi-codec environment, the method comprising:
creating a received codec list by receiving a transmit codec comprised in a call setting message from a transmission device and the number of transcodings of the transmit codec, which has been performed from a codec of an initial transmission device; and
selecting a codec having the highest priority among at least one internal codec as a response codec based on the number of transcodings of the received codec list.

6. The method of claim 5, further comprising:
if the at least one internal codec has the same priority, creating a codec Quality of Service (QoS) list containing total codecs of the multiple networks and quality information of each of the total codecs; and
selecting a codec having the highest priority as a response codec based on the codec quality information of the codec QoS list.

7. A transcoding device for minimizing the number of transcodings between network devices in a multi-network multi-codec environment, the transcoding device comprising:
a received codec list creator creating a received codec list by receiving a transmit codec comprised in a call setting message from a transmission device and the number of transcodings of the transmit codec, which has been performed from a codec of an initial transmission device;
a codec Quality of Service (QoS) list creator creating a codec QoS list containing total codecs of the multi-network and quality information of each of the total codecs;
a transcodec list creator creating a transcodec list containing internally providable transcodecs and quality information of the transcodecs based on the codec QoS list; and
an updated codec list creator creating an updated codec list by adding codecs of the transcodec list matching codecs of the received codec list to the received codec list and adjusting codec priority according to the number of transcodings.

8. The transcoding device of claim 7, wherein the updated codec list creator creates the updated codec list by adding codecs of a transcodec matching by comparing a first codec of the transcodec list to codecs of the received codec list to the received codec list together with the number of transcodings performed from the codec of the initial transmission device.

9. The transcoding device of claim 8, wherein the updated codec list creator creates the updated codec list by adjusting priorities of codecs of the updated codec list using the transcodec quality information of the transcodec list if the number of transcodings is the same.

10. A reception device for minimizing the number of transcodings between network devices in a multi-network multi-codec environment, the reception device comprising:
a received codec list creator creating a received codec list by receiving a transmit codec comprised in a call setting message from a transmission device and the number of transcodings of the transmit codec, which has been performed from a codec of an initial transmission device; and
a response codec selector selecting a codec having the highest priority among at least one internal codec as a response codec based on the number of transcodings of the received codec list.

11. The reception device of claim 10, further comprising a codec Quality of Service (QoS) list creator creating a codec QoS list containing total codecs of the multiple networks and quality information of each of the total codecs.

12. The reception device of claim 11, wherein the response codec selector selects a codec having the highest priority as a response codec based on the codec quality information of the codec QoS list if the at least one internal codec has the same priority.

13. A computer readable recording medium storing a computer readable program for executing the method of one of claims 1 through 6.
